(19) United States
(12) Patent Application Publication
(10) Pub. No.: US 2010/0115721 A1
(43) Pub. Date: May 13, 2010

(54) ENGINE CLEANING SYSTEM AND METHOD FOR CLEANING CARBON DEPOSITS IN ENGINES

(75) Inventors: Kulasegaram Gugaratshan, Dunlap, IL (US); Orhan Altin, Peoria, IL (US); Eric Lucas, Washburn, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/266,681

(22) Filed: Nov. 7, 2008

(51) Int. Cl. H01T 21/00

(52) U.S. Cl. 15/104.011

(57) ABSTRACT

Methods and apparatuses for removing carbon deposits from pistons of internal combustion engines with water are disclosed that avoid disassembly or overhauling the engines. In one aspect, a manifold having at least one water inlet and an internal passageway network is connected to a water source for delivering water to the cylinders through the manifold. The disclosed cleaning apparatus may be installed on a vehicle or provided as original vehicle equipment and used during normal engine operations. A method for cleaning carbon deposits in an internal combustion engine and a modified manifold for delivering water to the cylinders of an engine are also disclosed.

### TECHNICAL FIELD

This disclosure relates generally to an apparatus and a method for cleaning carbon deposits that accumulate on various surfaces in an internal combustion engine.

### BACKGROUND

A typical internal combustion engine includes a plurality of combustion chambers or cylinders, each accommodating a reciprocating piston. The pistons typically include a pair of compression rings to prevent the escape of gases from the cylinder around the sides of the piston during the compression stroke of the piston. The pistons also typically include an oil control ring to preclude oil from entering the combustion chamber.

One problem associated with all internal combustion engines is the accumulation of carbon deposits on various piston surfaces, such as on the top lands and in the compression ring and oil control ring grooves. The carbon deposits become very hard over time and, unless removed regularly, will lead to increased oil consumption and the seal between the piston and cylinder liner become compromised. Further, the long term presence of carbon deposits will cause the cylinder liner or bore to be polished or worn, which leads to increased oil consumption and may require the liner to be replaced. As these carbon deposits build up sufficiently over time, engine performance degrades and the failure rate of the engine increases.

Various engine conditioning procedures and systems have been devised for removing the carbon deposits from internal combustion engines. One known engine conditioning procedure involves disassembly and/or overhaul of an engine and individual cleaning and/or replacement of some engine parts. These engine cleaning and overhaul procedures are complex, time consuming, costly, and require the services of a skilled mechanic. Nevertheless, the disassembly and overhaul procedures permit a direct inspection of the engine parts and thereby enable an accurate visual determination of the cleanliness and condition of the inspected parts. If the disassembly procedure is employed, new pistons, rings and liners are typically installed.

Known carbon cleaning agents for use on disassembled engine components include ULTRA ONE™ (sodium metasilicate, surfactants, water), GOODWRENCH® TOP ENGINE CLEANER (2-butoxyethanol, naphtha, 4-methyl-2-pentanol, 9-octadecendic acid) and PRO SERIES SIMPLE GREEN® MAX AUTOMOTIVE CLEANER & DEGREASER (2-butoxyethanol, water). Other engine cleaning agents include acetone, benzyl alcohol, propylene glycol, ethylene glycol, polyol esters, n-methylpyrrolidone, ethoxylated nonylphenols and others. Steam cleaning and cleaning with dry ice (CO₂) are also known.

Even though disassembly/overhauling is the only known method for cleaning combustion chambers that is 100% effective at removing carbon deposits or replacing damaged parts, liquid cleaners and additives are routinely used to clean combustion chambers to avoid the downtime and costs associated with the disassembly of the engine. One such method involves manually or mechanically injecting an alcohol based cleaner into the combustion chamber after removing the spark plug. This method is obviously inapplicable to diesel engines. Further, alcohol based products tend to cause the carbon deposits to break off as particles rather than dissolve in the cleaning solvent. When carbon deposit particles break off, they can become trapped between the piston rings, causing engine problems and increased oil consumption.

Other less complicated procedures involve the use of a carbon cleaning agent in the form of a fuel additive and/or oil additive without disassembly of the engine. These procedures do not permit a determination of the effectiveness of the carbon cleaning operation or an inspection of the parts. Thus, while fuel or oil additives for cleaning carbon deposits are known, such fuel or oil additives take a long time to work, can be difficult to evaluate, and are often ineffective. Known fuel additives include napthenic petroleum distillates, aliphatic naphthas, polyolefin amines, propoxylated alcohols, and light aromatic petroleum distillates in various combinations as well as other materials that are sold under a variety of trade names. Known oil additives include proprietary detergents and diluent oils and are also sold under a variety of trade names.

Some procedures go to great lengths to avoid disassembly and/or overhaul of the engine. For example, one five-step procedure that employs five different hydrocarbon-based liquids including: a fuel additive; an oil crankcase additive; an aerosol air intake cleaner; an air induction cleaner; and a piston/ring cleaner added through the spark plug openings.

Another problem associated with all of the above techniques for removing carbon deposits from internal combustion engines is the reliance upon hydrocarbon-based materials such as alcohols, surfactants and solvents, all of which can leave deposits in the form of residues on the piston surfaces. Further, penetration into the top compression ring grooves remains problematic as both polar and non-polar hydrocarbon-based solvents are ineffective in removing or dislodging carbon deposits from compression ring grooves.

### SUMMARY OF THE DISCLOSURE

In one aspect of this disclosure, a piston cleaning apparatus, a method for cleaning carbon deposits from an internal combustion engine and an improved internal combustion engine manifold are disclosed that enable pistons to be cleaned with water, such as deionized water, for improved results over the techniques taught in the prior art, and without disassembling or overhauling the engine.

In another aspect of this disclosure, a piston cleaning apparatus is disclosed for an internal combustion engine having at least one cylinder that accommodates a piston that is susceptible to accumulating carbon deposits as discussed above. The piston cleaning apparatus comprises a manifold having at least one water inlet and an internal passageway network. The manifold may be an air intake manifold, an exhaust manifold or combination of the two. The internal passageway network provides fluid communication between at least one water inlet and the cylinder. The piston cleaning apparatus also comprises a water source in communication with the water inlet. The water source may optionally be in communication with a pressure source for delivering water to the manifold and the cylinder.

In yet another aspect of this disclosure, a method for cleaning carbon deposits in an internal combustion engine is disclosed that comprises: operating the engine at a first speed; delivering water to the at least one water inlet for a first time period and at a first flow rate while operating the engine at the first speed; and increasing the engine speed to a second higher speed for a second time period. Water delivery to the cylinders may be stopped during the time period when the engine is operated at the second higher speed.

In another aspect, a manifold for an internal combustion engine is disclosed that is connectable to a pressurized water source for delivering water to a cylinder of the engine while the engine is running. The manifold comprises an internal passageway network passageway providing fluid communication to the cylinder of the engine, and at least one water inlet in communication with the internal passageway network of the manifold and the cylinder.

### BRIEF DESCRIPTION OF THE DRAWINGS

FIG. 1 is a partial schematic illustration of an internal combustion engine equipped with a piston cleaning apparatus and a modified manifold in accordance with this disclosure;

FIG. 1A is a partial and enlarged view of the piston and cylinder shown in FIG. 1, particularly illustrating the lands and grooves of the piston that are susceptible to carbon deposit accumulation;

FIG. 2 is another partial schematic illustration of an internal combustion engine and modified manifold for delivering water to the combustion chambers in accordance with one aspect of this disclosure; and

FIG. 3 is another partial schematic illustration of an internal combustion engine and modified manifold for delivering water to the combustion chambers in accordance with another aspect of this disclosure.

### DETAILED DESCRIPTION

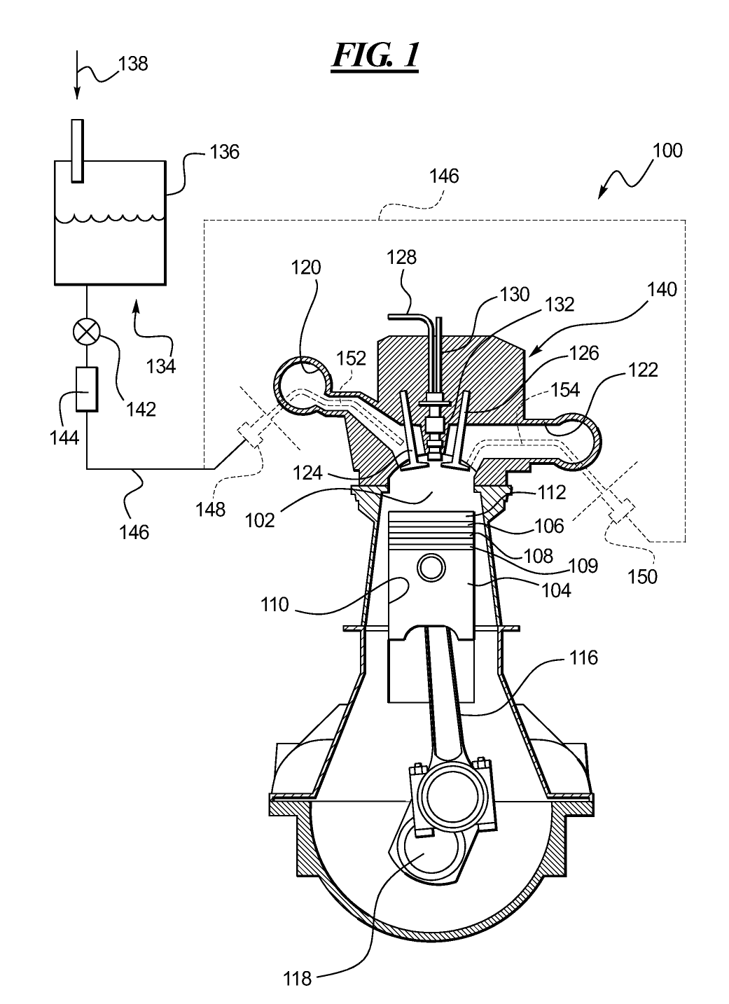

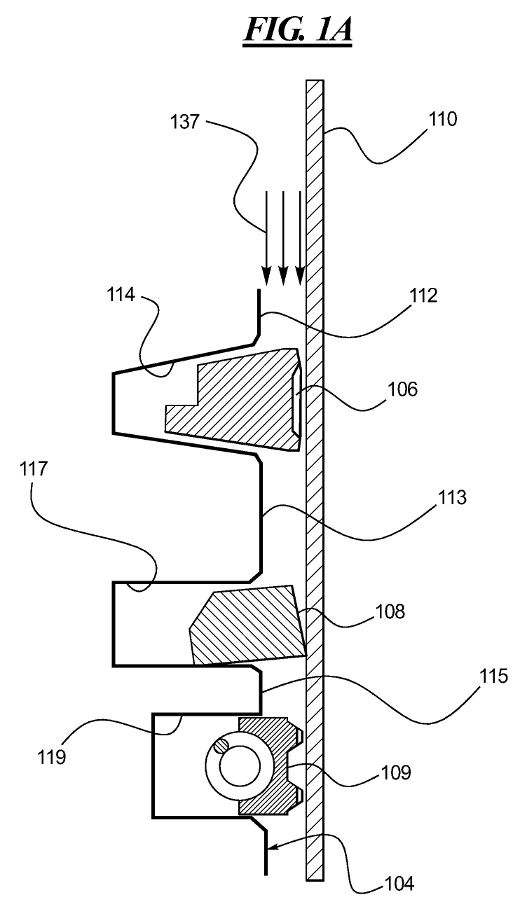

An internal combustion engine 100 that includes at least one combustion chamber 102 associated with a piston 104 is shown in FIGS. 1 and 1A. The piston 102 may include a pair of compression rings 106, 108 and an oil control ring 109. The compression rings 106, 108 serve to prevent the escape of gases from the chamber 102 around the sides of the piston 104 and out of the cylinder 110 during the compression stroke of the piston 104. The oil control ring 109 inhibits oil from leaking upward past the oil control ring 109 and compression rings 106, 108 and towards the exhaust passageway 122 as shown in FIG. 1. FIG. 1A particularly illustrates the surfaces of the piston 104 that tend to accumulate carbon deposits during normal use such as the top land 112 disposed above the compression ring 106, the second land 113 disposed between the compression rings 106, 108, the third land 115 disposed between the compression ring 108 and oil control ring 109, as well as the compression ring grooves 114, 117 and the oil control ring groove 119.

While this disclosure is directed primarily at the removal of carbon deposits that accumulate on the surfaces illustrated in FIG. 1A, FIG. 1 also shows a rocker arm 116, crankshaft 118, air intake passageway 120, the exhaust passageway 122, and intake and exhaust valve members 124, 126 respectively. Fuel is provided through a fuel injection line 128 which is combined with compressed air flowing through the line 130 in the fuel/air injection nozzle 132 before the mixture of fuel and air is delivered to the combustion chamber 102.

During the operation of an internal combustion engine, deposits of carbon and similar materials form on the various surfaces of the engine pistons, including the top land 112, second and third lands 113, 115, compression ring grooves 114, 117 and oil control ring groove 119 as shown in FIG. 1A. Unless removed regularly, these carbon deposits can build up sufficiently to degrade engine performance, increase the failure rate of an engine and substantially increase oil consumption.

Therefore, FIG. 1 also illustrates the use of a cleaning apparatus 134 that delivers water to a combustion chamber 102. The cleaning apparatus 134 includes a water source or tank 136 that may be pressurized, such as by a compressed air source shown schematically at 138, which can conveniently be the “shop air” that is readily available in vehicle or truck maintenance facilities. A pump (not shown) may also be employed as a pressure source, or the water source 136 may be elevated to provide water flow 137 (FIG. 1A) to the engine 100. Other means for generating flow from the water source 136 to the engine 100 or the manifold 140 will be apparent to those skilled in the art. As noted above, deionized water will not leave a residue on the surfaces of the piston 104, the interior surface of the cylinder 110 or other engine surfaces exposed to the deionized water. However, the use of deionized water is not required.

As illustrated in FIG. 1, the water source 136 may be linked to either an air intake passageway 120 of the manifold 140 or an exhaust passageway 122 of the manifold 140. In the structure illustrated in FIG. 1, the manifold 140 includes both the air intake passageway 120 and the exhaust passageway 122. For a multiple cylinder engine, the manifold 140 may include a network of air intake passageways 120 for delivering air to the combustion chambers 102 and a network of exhaust passageways 122 for exhausting air from the combustion chambers 102.

The water source or reservoir 136 may be in the form of a tank, such as a tank or vessel that may be pressurized with a compressed air source 138, be equipped with a pump or some other means (not shown), or gravity may be exploited to deliver the water to the manifold 140. The water source 136 may be connected to a flow regulator 142 which may be a controllable valve. Also, a flow meter 144 may be employed which can be used to calculate or keep track of the amount of water delivered to the manifold 140 and the combustion chambers 102.

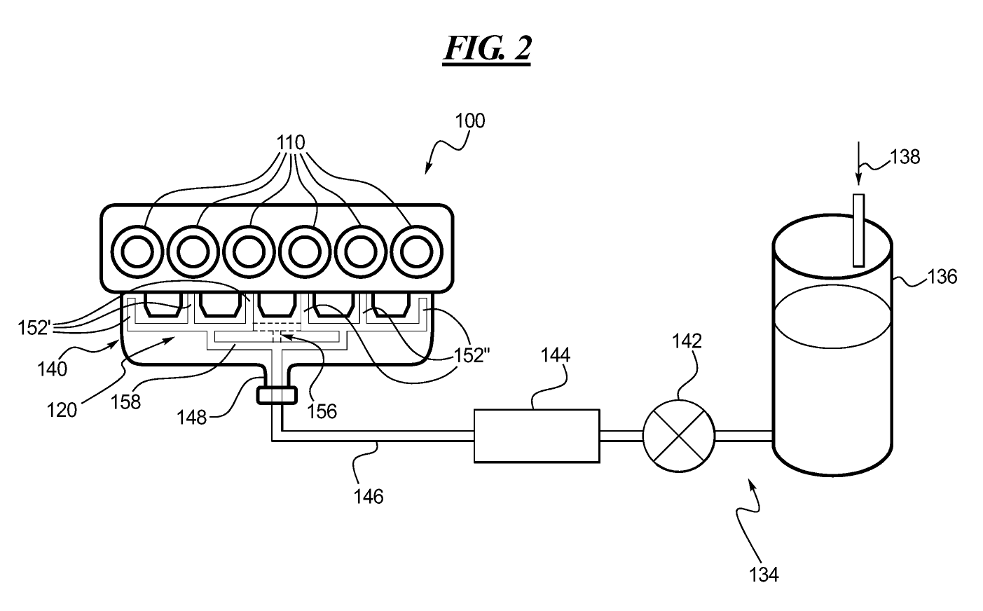

As shown in the schematic illustrations of FIGS. 1-2, the water source 136 may be linked to the manifold 140 by a single conduit 146 (although it may be interrupted by the flow regulator 142 and flow meter 144). Referring to FIG. 1, the conduit 146 may be connected to a water inlet 148 that provides communication between the water source 136 and the air intake passageway 120 or a water inlet 150 that provides communication between the water source 136 and the exhaust passageway 122. Use of the air intake passageway 120 of the manifold 140 may be effectively employed because the water may be delivered to the combustion chambers 102 while the engine is running at the low speed and therefore less pressure may be required to deliver water to the combustion chambers 102 when the air intake passageway 120 is utilized versus the exhaust passageway 122. However, use of the exhaust passageway 122 is also clearly feasible and within the scope of this disclosure.

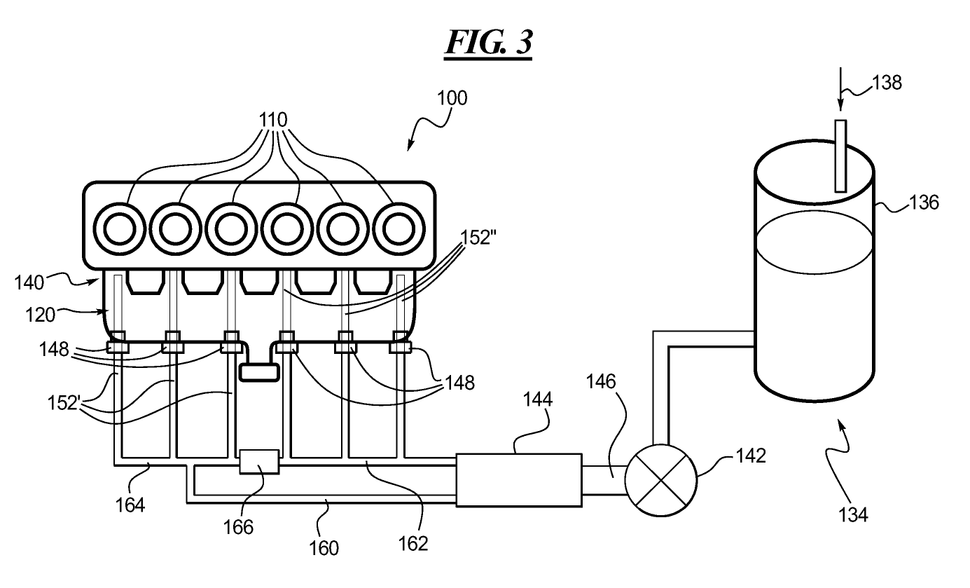

The water inlets 148, 150 may be simple fittings mounted to an exterior of the manifold 140 as illustrated in FIG. 1. The water inlets 148, 150 may also be an integral part of the manifold 140 structure as illustrated in FIG. 2. The water may be delivered to the intake or exhaust passageways 120, 122 directly through the inlets 148, 150. Further, as illustrated in FIGS. 2-3, a conduit network may be disposed within the manifold 140 to facilitate the delivery of water to the combustion chambers 102. Still referring to FIG. 1, the water inlets 148, 150 may be connected to conduits 152, 154 disposed within the air intake passageway 120 or exhaust passageway 122. While the use of the internal conduits 152, 154 provide a more reliable and even distribution of water to the combustion chambers 102 of a multiple-cylinder engine, the internal conduits 152, 154 are not necessary and the passageways or passageway networks 120, 122 of the manifold 140 may be used without the additional conduits shown at 152, 154 in FIG. 1.

Turning to FIG. 2, the water inlet 148 as shown may be connected to a plurality of conduits 152′, 152″ in parallel. Specifically, the conduit 146 passing through the water inlet 148 may be connected to the six conduits 152′, 152″ leading to the cylinders 110 using a T-connection shown in phantom at 156 in FIG. 2. Alternatively, the conduit 146 and water inlet 148 may be connected to a branch conduit such as the one shown at 158 in FIG. 2 that provides parallel communication to three conduits 152′ shown at the left in FIG. 2 and three conduits 152″ shown at the right in FIG. 2. While the reference numeral 148 is used for the water inlet of FIG. 2 indicating that the water inlet 148 is connected to the air intake passageway 120 of the manifold 140, it will be noted that the design of FIG. 2 is equally applicable to use of a water inlet 150 connected to an exhaust passageway 122 of the manifold 140 as illustrated in FIG. 1. In short, this disclosure is intended to encompass the use of both the air intake passageways 120 as well as the exhaust passageways 122 of a manifold 140 for communicating water to the combustion chambers 102.

Another embodiment is illustrated in FIG. 3. The flow meter 144 splits the water flowing through the conduit 146 into two flow paths illustrated by the conduits 160, 162. The conduit 162 provides communication to the conduits 152″ shown at the right in FIG. 3 and the conduit 160 provides communication to the conduit 164 which provides communication to the conduits 152′ shown at the left in FIG. 3. A block 166 is shown that separates the conduits 162, 164. As an alternative, the branch conduit 160 may be eliminated and the conduits 162, 164 connected (eliminating the block 166) to provide parallel communication between all six conduits 152′, 152″ and the water source 136. The conduits 152′, 152″ pass through the manifold 140 through the plurality of water inlets shown generally at 148. Again, while FIG. 3 is directed toward delivering water to the air intake passageway 120 of the manifold 140, the design of FIG. 3 is also equally applicable to delivery of water through the exhaust passageway 122 of the manifold 140 as illustrated schematically in FIG. 1.

The employment of the internal conduits 152, 152′, 152″ and 154 as illustrated in FIGS. 1-3 insures equal distribution of the deionized water to the individual cylinders 110. Equal distribution of the water is advantageous to provide uniform cleaning of the cylinders 110 and pistons 104. Also, equal water distribution prevents excess water from being delivered to one cylinder and/or too little water delivered to another cylinder, both of which could result in reduced carbon deposit removal. The conduits 146, 152, 152′, 152″, 154, 160, 164 may be fabricated from flexible or pliable materials. Conduits that are disposed exterior to the manifold 140 such as the conduits 146, 160, 164 may be fabricated from a suitable plastic material. The conduits that extend inside the manifold 140, such as the conduits 152, 152′, 152″, 154 should be fabricated from a suitable heat-resistant and pliable material such as copper or aluminum tubing. The water inlets 148, 150 may be standard fittings, such as those equipped with a check valve.

After extensive research and testing, applicants have surprisingly found that operating the engine at a low speed (and under a low load) while delivering water into the combustion chambers 102 when the piston surfaces and the exhaust gases are at a lower temperature, e.g., less than about 100° C., enables the warm liquid water to penetrate the “pores,” cracks or fissures of the carbon deposits that have accumulated on the piston surfaces. This penetration can occur within a shorter time period, which can range from about 2 to about 8 minutes. As used herein, the term “about” when used to modify a numerical value means plus or minus ten percent (±10%) of the stated value. For at least some six cylinder diesel engines, a suitable low engine speed for the water delivery phase can range from about 400 to about 1200 rpm. The flow rate of water delivered during the first water delivery phase may be controlled so that a cumulative amount of water delivered to the cylinders is less than about 5% of the sump oil volume, with ranges of less than 4% and less than 3% being particularly effective. For example, if the vehicle includes 10 gallons (37.85 liters) of sump oil, and the time period for the water delivery phase is 5 minutes, an appropriate water flow rate may be about 1100 grams or milliliters of water per minute or less.

After the liquid water has penetrated the structures of the carbon deposits at the lower temperature, the engine speed may be increased thereby increasing the temperature of the pistons and exhaust gases to greater than 100° C., thereby vaporizing the water or turning it into steam. The steam expands within the pores, cracks and/or fissures of the carbon deposits, thereby breaking the deposit structures and causing the broken-off pieces of carbon deposits to flow out of the combustion chamber through the exhaust stream. After the engine speed has been increased, the water delivery may be stopped or at least substantially reduced. Stopping the water delivery altogether during the second higher engine speed phase can help ensure a fast or even violent vaporization of the water that has penetrated the carbon deposit structures, thereby encouraging damage and breakage of the carbon deposit structures and the removal of the broken off carbon deposit through the exhaust stream. Further, the second phase can be longer than the first phase; the second phase can range from about 5 to about 25 minutes. The higher engine speeds used during the second phase to increase the temperature of the pistons and the exhaust gases can range from about 1200 to about 2400 rpm for at least some six cylinder diesel engines. The two phases may be sequentially repeated for an extensive time period ranging up to four or more hours.

The disclosed apparatuses and methods may be automated. For example, any one or more of the flow regulator 142, flow meter 144, compressed air source 138, fluid level sensor in the water source 136 tank (not shown), pressure sensor in water source 136 tank (not shown), engine throttle (not shown), and exhaust gas temperature sensor (not shown) may be linked to a controller or computer for controlling the duration of the two phases (low speed-low temperature-water delivery; high speed-high temperature), the water flow, the engine speed and for monitoring the exhaust gas temperatures during the first and second phases. However, one of the advantages of the disclosed methods and apparatuses is the simplicity and ease in which the disclosed methods and apparatuses can be used. Hence, a sophisticated and automated control system is not necessary and a high level of skill is not required to either carry out the disclosed methods manually or to use the disclosed apparatuses manually.

### INDUSTRIAL APPLICABILITY

Instead of cleaning agents that rely upon alcohol, organic solvents or surfactants that can leave the residue on the piston and/or cylinder, the disclosed methods and apparatus use water as the cleaning agent/solvent. To avoid leaving mineral residues on the engine components, the water may be deionized water. After extensive research, it has been surprisingly found that the use of deionized water while operating the engine at a low speed, and therefore a low temperature below the boiling point of water (<100° C.), provides an environment conducive to the heated liquid water penetrating carbon deposits on the upper land surfaces of the piston as well as carbon deposits disposed in the compression seal ring and oil control ring grooves of the piston. After an appropriate time period of delivering water into the combustion chambers while the engine is running at a low speed, the pores, cracks or fissures of the carbon deposits have been substantially penetrated by the heated liquid water. Then, the engine speed may be increased thereby increasing the temperature in the combustion chamber and the water that has permeated the carbon deposits. Without being bound to any particular theory, as the temperature of the engine increases while it is operated at a higher speed, the water is vaporized or turned into steam thereby causing the water to expand within the carbon deposits and causing the carbon deposits to crack and break off from the surfaces of the piston and removed through the exhaust stream.

It has been surprisingly found that the combination of water and the operation of the engine at two different speeds and therefore two different temperatures provides an improved mechanism for removing carbon deposits that is less expensive and more efficient than techniques that rely upon the use of expensive hydrocarbon-based solvents. Deionized water may be particularly effective because it will not leave any mineral residue on the engine components. However, the use of deionized water is not required.

Generally, water may be delivered into the cylinder ports (either intake or exhaust) while operating the engine at a low speed, and at a low load for a time ranging from about 2 to about 8 minutes, although a range of from about 3 to about 7 minutes may be employed, and in one example, a time period of about 5 minutes for at least some six cylinder diesel engines has been found to be particularly effective. The engine exhaust temperature during this first phase or first time period may be less than the boiling point of water (<100° C.). It will be apparent to those skilled in the art that modifying the engine speed and time period for the water delivery may be necessary to optimize the exhaust temperature close to but below 100° C. to enhance the water penetration into the carbon deposits. For a six cylinder diesel engine, the engine speed during the delivery of the water can range from about 400 to about 1200 rpm, although a range of from about 600 to about 1000 rpm will be applicable to many six cylinder diesel engines. For example, useful first engine speeds of about 700 and about 800 rpm have been found to be effective.

After the initial water delivery, the water delivery may be stopped and the engine speed may be increased to increase the temperature of the pistons. The time period for the second phase where the engine is operated at a higher speed but under a low load condition can range from about 5 to about 25 minutes, with a range of from about 10 to about 20 minutes being particularly effective. For example, a time period of about 15 minutes has been found to provide good results for at least one six cylinder diesel engine. The increased engine speed during this second time period can range from about 1200 to about 2400 rpm. Alternatively, a range of from about 1600 to about 2000 rpm may be used. For some six cylinder diesel engines, a useful higher-speed is about 1800 rpm.

During the second higher speed phase, the water flow 137 shown in FIG. 1A will most likely not reach the top land 112, second and third lands 113, 115 and compression seal and oil control ring grooves 114, 117, 119 of the piston 104 but will most likely pass out through the exhaust passageway 122 (FIG. 1). The second high speed phase generates heat, thereby enabling the water to quickly evaporate and increase the speed at which hard carbon deposit layers to break off. Thus, the second high speed phase provides a mechanical cleaning action and the water flow may not be needed. Operating both the first water delivery phase and second high speed phase under a low load avoids the use of dynamometers.

The amount of water delivered to the cylinders may also be controlled. It has been found that a cumulative amount of water delivered to the engine cylinders during the first, low engine speed time period should be less than about 5% of the total volume of sump oil, with ranges of less than about 4% and less than about 3% being particularly effective. For example, if the vehicle includes 10 gallons (37.85 liters) of sump oil, and the time period for the water delivery is 5 minutes, the water flow rate may be about 1100 grams or milliliters of water per minute or less to limit the water delivered during the first phase to slightly under about 3% of the sump oil volume. Of course, larger engines may utilize larger amounts or volumes of water, with some large diesel engines using up to about 3000 grams or milliliters of water per minute.

The engine load for the low speed water delivery phase will be dependent upon the particular engine being treated, but for a six cylinder diesel truck engine, the load during the water delivery can range from about 30 Nm to about 80 Nm, with a load of about 57 Nm for at least some six cylinder diesel engines being particularly effective. The load on the engine for the higher-speed water-free phase can range from about 200 Nm to about 300 Nm, with a load of about 254 Nm for at least some six cylinder diesel engines being particularly effective. The procedure can be repeated for as long as eight hours, depending upon the severity of the carbon deposits and the condition of the engine.

The disclosed methods and apparatuses can be used in any engine, such as four, six, eight and twelve cylinder engines, and engines of any configuration such as 1-engines or straight engines, V-engines, etc. The disclosed methods and cleaning apparatuses 134 may also be used on a vehicle during normal operation and maybe permanently mounted to the vehicle as original equipment or as a retrofit. That is, the water source 136 and cleaning apparatus 134 may be disposed on the vehicle and connected to the manifold 140. If necessary, a pump (not shown) could be used in place of the compressed air source 138.

One disclosed cleaning method comprises operating the engine at a low speed, under a low load and at a low temperature while delivering deionized water through the intake valves or through the exhaust valves of the engine cylinders while the engine is running at the low speed/low load/low temperature. During the delivery of the deionized water, the speed of the engine, the flow rate of water, and the duration or time period of the delivery of the deionized water may all be controlled. For example, the engine speed can range from about 400 to about 1200 rpm, the water delivery time period can range from about 2 to about 8 minutes and the water flow rate can be limited to less than about 5% of the volume of sump oil over the time interval. The low engine speed helps to maintain a low exhaust temperature that may be below the boiling point of water (100° C.). The water delivery may then stopped and the engine speed increased to anywhere from greater than about 1200 rpm to about 2400 rpm, with no water flow or a reduced water flow and for a longer time period ranging from about 10 to about 25 minutes.

The disclosed methods may be used to maintain and prolong the life of both diesel and gasoline internal combustion engines. Specifically, the disclosed methods may be easily carried out in a typical maintenance facility. Deionized water sources 136 in the form of suitable tanks are readily available. The water sources 136 can be equipped with a pump or may be connected to a compressed air source 138 that is typically used in vehicle maintenance facilities for inflating tires and operating air powered tools. To practice one disclosed embodiment, the maintenance facility needs only to purchase a simple valve or flow controller 142, a flow meter 144 and the necessary conduits or tubing to connect the water source 136 to an engine manifold 140.

The engine manifold 140 can be modified for purposes of carrying the disclosed method or for accommodating the connection to the disclosed cleaning apparatus 134. Existing manifolds 140 can be readily retrofitted with one or more water inlets 148, 150 for connection to the water source 136. Further, as the value of the disclosed maintenance technique becomes apparent to those skilled in the art of engine maintenance, manifolds 140 readily equipped to be connected to a pressurized water source may be provided without substantially redesigning current engine manifolds. Many manifolds already include an inlet for the introduction of cleaning solvents for the cylinders. Applicants have surprisingly found that deionized water or water in general is a superior solvent choice, particularly when used with the methods disclosed above.

The disclosed engine cleaning methods and apparatuses are estimated to cost about 10% of the costs associated with an engine overhaul that includes the replacement of the pistons, rings and liners. The disclosed cleaning methods and apparatuses are also estimated to cost substantially less than any carbon deposit cleaning program that relies upon fuel and/or oil additives.

What is claimed is:

1. A piston cleaning apparatus for an internal combustion engine having at least one cylinder, the at least one cylinder accommodating a piston, the apparatus comprising:
a manifold having an internal passageway and at least one water inlet, the internal passageway providing fluid communication between at least one water inlet and at least one cylinder; and
a water source in communication with the at least one water inlet for delivering water to the manifold and the at least one cylinder.

2. The apparatus of claim 1, wherein the water is deionized water.

3. The apparatus of claim 1, wherein the internal passageway of the manifold includes an internal passageway network, and
the apparatus further includes a conduit network disposed within the internal passageway network of the manifold that provides communication between the at least one water inlet and the at least one cylinder.

4. The apparatus of claim 1, wherein the internal passageway of the manifold includes an internal passageway network,
the engine includes a plurality of cylinders, and
the apparatus further includes a plurality of water inlets connected to the water source, each water inlet connected to a conduit disposed in the internal passageway network of the manifold that communicates water from its respective water inlet to one of the cylinders.

5. The combination of claim 1, further comprising a pressure source in communication with the water source for enhancing water flow from the water source to the water inlet.

6. The apparatus of claim 5, wherein the pressure source is a source of compressed air.

7. The apparatus of claim 5, wherein the pressure source is a pump.

8. The apparatus of claim 3, wherein the internal passageway of the manifold includes an internal passageway network and the manifold further includes an air intake,
the apparatus further including a conduit network disposed within the internal passageway network of the manifold,
the engine further includes a plurality of cylinders, and
the internal passageway network providing communication between the air intake and the plurality of cylinders and the conduit network providing communication between the at least one water inlet and the plurality of cylinders.

9. A method for cleaning carbon deposits in an internal combustion engine having a manifold connected to at least one cylinder, the at least one cylinder accommodating a piston, the manifold having at least one water inlet and an internal passageway network providing communication between the at least one water inlet and the at least one cylinder, the method comprising:
operating the engine at a first speed;
delivering water to the at least one water inlet for a first time period and at a first flow rate while operating the engine at a first speed; and
increasing a speed of the engine to a second higher speed for a second time period.

10. The method of claim 9, further comprising:
stopping the delivering of the water to the at least one water inlet after the first time period and before increasing the speed of the engine to the second higher speed.

11. The method of claim 9, wherein the first speed of the engine ranges from about 400 to about 1200 rpm and the second higher speed ranges from greater than 1200 to about 2400 rpm.

12. The method of claim 9, wherein the first time period ranges from about 3 to about 8 minutes and the second time period ranges from about 10 to about 20 minutes.

13. The method of claim 9, wherein the water is deionized water.

14. The method of claim 9, further comprising providing a head pressure to the water delivered to the at least one water inlet using pressurized air.

15. The method of claim 10, wherein the first speed of the engine ranges from about 600 to about 1000 rpm and the second higher speed ranges from about 1400 to about 2200 rpm.

16. The method of claim 15, wherein the first time period ranges from about 3 to about 8 minutes and the second time period ranges from about 10 to about 20 minutes.

17. The method of claim 9, wherein the engine further comprises a sump oil reservoir containing a volume of sump oil, and the method further comprises:
controlling the first flow rate and a duration of the first time period so that an amount of water delivered to the manifold during the first time period is less than about 3% of the volume of sump oil.

18. A manifold for an internal combustion engine that is connectable to a pressurized water source for delivering water to cylinders of the engine while the engine is operating, the manifold comprising:
an internal passageway network passageway providing fluid communication to a plurality of cylinders; and
at least one water inlet in communication with the internal passageway network and the plurality of cylinders.

19. The manifold of claim 18, further comprising a conduit network disposed within the internal passageway network of the manifold that provides communication between the at least one water inlet and the cylinders.

20. The manifold of claim 18, further comprising a plurality of water inlets, each water inlet connected to a conduit disposed within the internal passageway network of the manifold that communicates water from its respective water inlet to one of the cylinders.
